(19) United States
(12) Patent Application Publication
(10) Pub. No.: US 2008/0242550 A1
(43) Pub. Date: Oct. 2, 2008

(54) TUNABLE FILTER AND METHOD FOR FABRICATING THE SAME

(75) Inventors: Masatoshi ISHII, Kawasaki (JP); Kazunori YAMANAKA, Kawasaki (JP); John David BANIECKI, Kawasaki (JP); Akihiko AKASEGAWA, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/054,983

(22) Filed: Mar. 25, 2008

(30) Foreign Application Priority Data
Mar. 29, 2007 (JP) 2007-089168

(51) Int. Cl. H01P 1/203; H01P 11/00

(52) U.S. Cl. 505/210; 333/205; 29/600

(57) ABSTRACT

The tunable filter includes two or more adjacent resonators, and a variable capacitive coupler formed on the same substrate where the resonators are formed provided between the resonators. The tunable filter is appropriate for integration which can efficiently change a coupling capacitance between the resonators using a simple structure.

### CROSS-REFERENCE TO RELATED APPLICATION

This application is based upon and claims the benefit of priority from the prior Japanese Patent Application No. 2007-089168 filed on Mar. 29, 2007, the entire contents of which are incorporated herein by reference.

### BACKGROUND OF THE INVENTION

1. Field of the Invention

The present invention relates to a high-frequency circuit element used in the field of wireless communication and the like.

2. Description of Related Art

In connection with the recent widespread use of mobile phones or advance thereof, high-speed, large-capacity transmission has become an essential technology. To achieve high-speed, large-capacity communication, it is necessary to reserve a broad frequency band, and the frequency band used in wireless communication has been shifted toward the high-frequency side. A filter for a mobile communication base station therefore needs to be a bandpass filter that efficiently transmits only a desired frequency in a high-frequency band. Since superconductors have significantly smaller surface resistance even in a high frequency region than typical electric conductors, it is expected that use of a superconductor may achieve a low-loss, high-Q resonator, which makes a superconductor a promising device as a filter for mobile communication base stations.

On the other hand, a high-frequency circuit element used for mobile communication needs to have frequency tuning capability. For example, to provide a tunable high-frequency bandpass filter, it is conceivable to combine a superconductive resonator pattern and a dielectric thin film for tuning filter characteristics. Application of a DC bias can greatly change the dielectric constant of a dielectric thin film. There have therefore been studies on a dielectric thin film to be applied to tunable devices, such as filters and phase shifters, in a high-frequency circuit.

However, a dielectric thin film typically has a large dielectric loss. Therefore, when a dielectric thin film is used in a resonant filter element, it is difficult to provide high-Q filter characteristics. There has been proposed a configuration in which a varactor element (variable capacitive element) is disposed in an area other than those where electric current or electric field concentrates to prevent dielectric loss and degradation of unloaded Q (JP-A-6-045812, for example). However, in this method as well, reduction in the Q value is expected because the varactor element is disposed in part of the resonator.

To control the coupling between resonators, there has been proposed a method for changing the coupling by disposing a dielectric body made of a dielectric material in the gap between the resonators in such a way that the dielectric body faces the resonators, and applying a voltage to the dielectric body. In this method, since the dielectric body needs to face the resonators, the configuration is structurally unsuitable for integration.

### SUMMARY

In a first aspect of an embodiment, there is provided a variable capacitive tunable filter. The tunable filter includes two or more resonators, and a variable capacitive coupler formed on the same substrate where the resonators are formed, with the variable capacitive coupler provided between the resonators adjacent to each other.

In a second aspect of an embodiment, there is provided a method for fabricating a tunable filter. The fabrication method includes the step of forming two or more resonator patterns, an electrode pattern of a capacitive coupling element positioned between the two or more resonator patterns, and a wiring line for applying a bias voltage to the capacitive coupling element on the same substrate in the same process.

### BRIEF DESCRIPTION OF THE DRAWINGS

FIGS. 1A to 1C show the structure of a tunable filter according to an embodiment of the invention;

FIGS. 2A and 2B show an example of implementation of the tunable filter shown in FIGS. 1A to 1C;

FIG. 3 shows simulation graphs illustrating the S11 characteristic and the S21 characteristic when DC bias voltages are applied to the tunable filter shown in FIG. 1 and when no DC bias is applied;

FIG. 4 shows simulation graphs illustrating the S11 characteristic and the S21 characteristic when DC bias voltages are applied to the tunable filter shown in FIG. 1 and when no DC bias is applied; and

FIGS. 5A to 5E are process diagrams showing fabrication of a thin film capacitor for capacitive coupling used in the tunable filter shown in FIG. 1.

### DESCRIPTION OF THE PREFERRED EMBODIMENTS

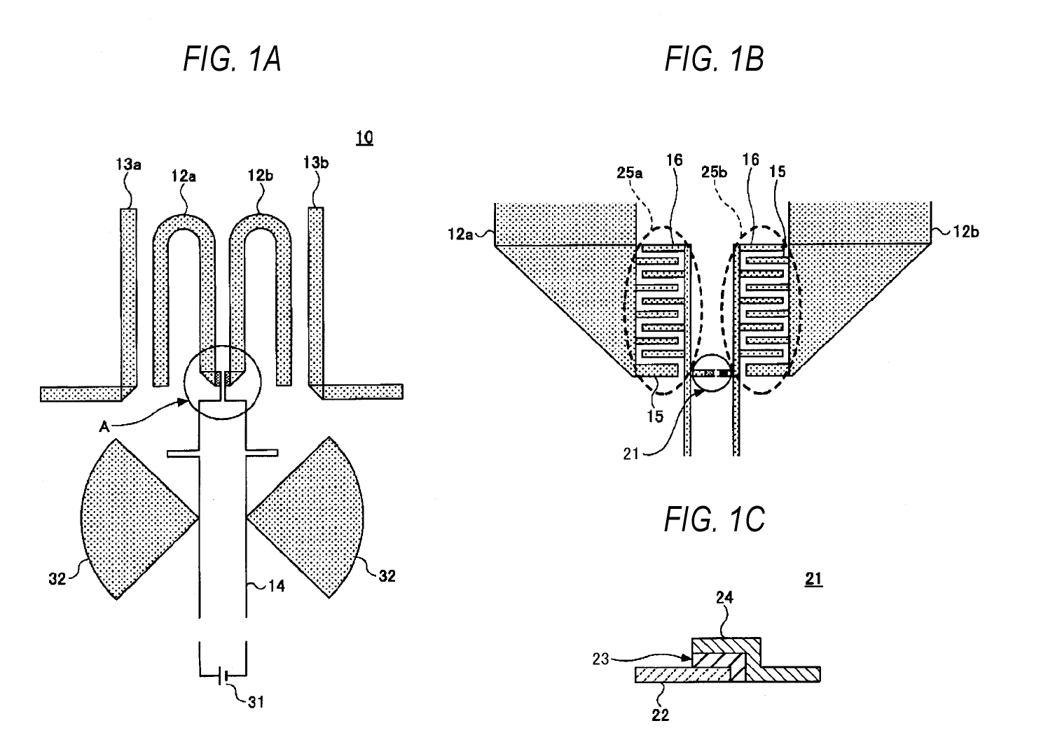

FIG. 1A is a configuration diagram of a tunable filter 10 according to an embodiment of the present invention. The tunable filter 10 in this embodiment includes two hairpin resonators 12a and 12b, a variable capacitive coupler A provided between the resonators 12a and 12b, a DC power supply 31, and a bias application wiring line 14 that couples the variable capacitive coupler A to the DC power supply 31. The tunable filter 10 also includes an input feeder 13a that supplies a signal to the resonators 12a and 12b, and an output feeder 13b that transmits an output signal from the resonators 12a and 12b. The input/output feeders 13a and 13b are spatially coupled with the resonators 12a and 12b. Each of the hairpin resonators 12a and 12b has a linewidth of, for example, 500 μm, and a length of one-half the effective wavelength λ. It is noted that λ is the effective wavelength of a signal to be transmitted. The distance between the hairpin resonator 12 and the feeder 13 is, for example, 500 μm.

Fan-shaped stubs 32 are disposed somewhere in the middle of the bias application wiring line 14 coupled to the DC power supply 31. The stub 32 functions as a filter that removes AC components (high-frequency components). The stub 32 is disposed at a position λ/4 apart from the end of the variable capacitive coupler A.

FIG. 1B is an enlarged view of the variable capacitive coupler A. The variable capacitive coupler A includes two interdigital capacitors 25a and 25b, and a thin film capacitor 21 as a capacitive coupling element serially coupled between the interdigital capacitors 25a and 25b. In this exemplary configuration, the interdigital capacitor 25a, the thin film capacitor 21, the interdigital capacitor 25b are serially coupled in this order. Each of the interdigital capacitors 25a and 25b includes a comb electrode 15 formed at the open end of the resonator 12, and a comb electrode 16 that interdigitally faces the comb electrode 15. The comb electrode 16, which faces the comb electrode 15, is formed at the tip of the bias application wiring line 14. The width of each of the comb protrusions of the comb electrodes 15 and 16 is, for example, approximately 25 μm.

On the other hand, the thin film capacitor 21 includes a lower electrode 22, an upper electrode 24, and a thin film dielectric 23 sandwiched between the pair of electrodes, as shown in FIG. 1C. Preferable examples of the material of the thin film dielectric 23 are SrTiO₃ (hereinafter referred to as “STO” as appropriate), (Ba, Sr)TiO₃ (hereinafter referred to as “BST” as appropriate), and Bi_{1.5}Zn₁Nb_{1.5}O₇ (hereinafter referred to as “BZN” as appropriate).

By applying a bias voltage from the DC power supply 31 to the thin film dielectric 23 in the thin film capacitor 21, the dielectric constant of the thin film dielectric 23 is changed and hence the coupling between the two resonators 12a and 12b is changed. The interdigital capacitors 25a and 25b coupled to the respective ends of the thin film capacitor 21 serve as auxiliary capacitors that block the DC bias voltage from entering the resonators 12a and 12b and reduce change in capacitance of the whole tunable filter to be as minimal as possible when the bias voltage is applied. The capacitance of the thin film capacitor 21 for adjusting the coupling between the resonators is desirably as small as possible. This is because large capacitance makes the coupling too strong. Provision of the relatively large interdigital capacitors 25a and 25b on the respective ends of the thin film capacitor 21 is logically equivalent to insertion of a significantly small coupling capacitor 21 between the resonators 12a and 12b. Therefore, when application of a bias voltage changes the coupling between the resonators 12, the capacitance of the whole filter can be kept at a substantially fixed value.

In a preferred embodiment, the resonators 12a and 12b, the interdigital capacitors 25a and 25b, the lower electrode 22 of the thin film capacitor 21, and the bias application wiring line 14 are formed in the same plane by the same process. The material of these components may be an arbitrary conductive material or superconductive material. Examples of the superconductive material may be YBCO (Y—Ba—Cu—O), RBCO (R—Ba—Cu—O; as the R element, Y is replaced with Nd, Gd, Sm, or Ho), BSCCO (Bi—Sr—Ca—Cu—O), PBSCCO (Pb—Bi—Sr—Ca—Cu—O), and CBCCO (Cu-Bap-Caq-Cur-Ox, 1.5<p<2.5, 2.5<q<3.5, 3.5<r<4.5).

The feeders 13 and the stubs 32 can also be formed in the same plane by the same process. The bias application wiring line 14 is then electrically coupled to the DC power supply 31. The tunable filter is thus completed. In operation, a DC bias is applied to a bias application port to change the capacitance of the thin film capacitor 21, so as to control the band frequency of the tunable filter 10.

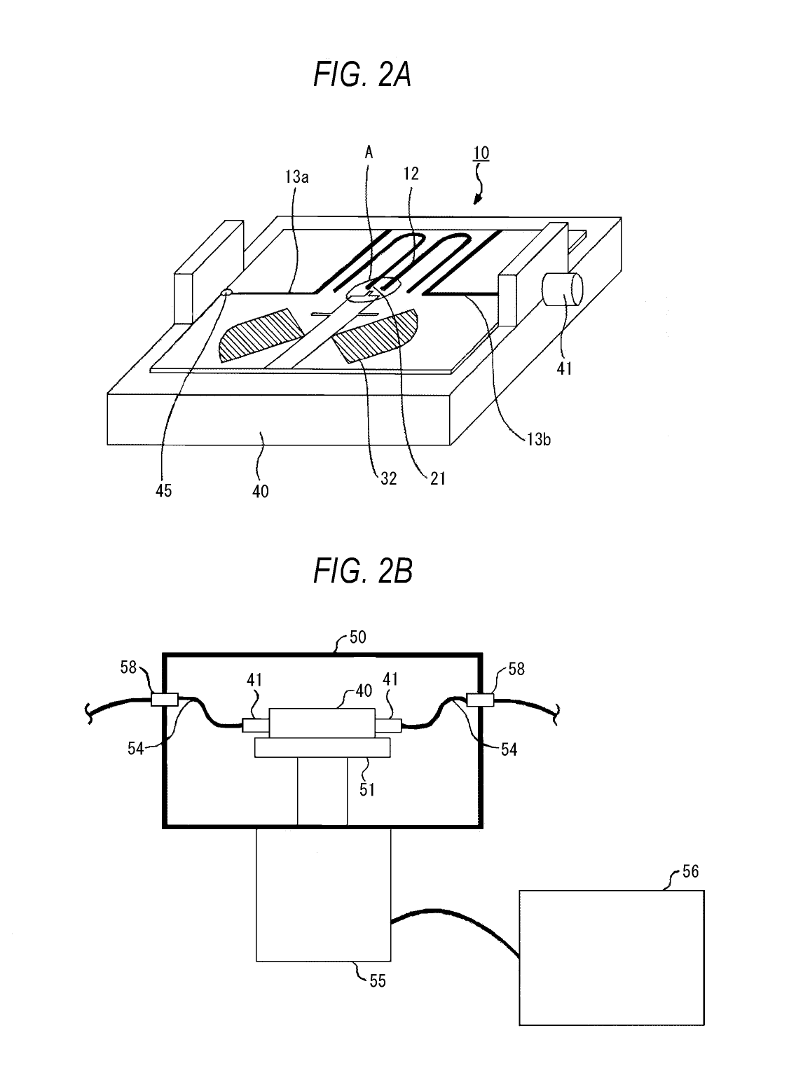

FIG. 2A is a perspective view of the tunable filter housed in a package. The tunable filter 10 is put in a metallic package 40, and connection electrodes 45, to which the input/output feeders 13a and 13b are coupled, are coupled to the central conductors (not shown) of coaxial connectors 41. The connection in the above process may be carried out by using an arbitrary method, such as ultrasonic thermocompression wire bonding, tape bonding, and soldering. After the connection between the coaxial connectors 41 and the connection electrodes 45, a package lid (not shown) is put in place for sealing. A signal to be filtered is inputted to the tunable filter 10 from a coaxial cable (see FIG. 2B) coupled to the coaxial connector 41, and a filtered output is outputted to a coaxial cable on the output side.

FIG. 2B is a schematic view showing the package mounted in an insulated vacuum container of a cooling apparatus. When the resonators 12 in the tunable filter are made of a superconductive material, the packaged tunable filter is held in the cooling apparatus, as shown in FIG. 2B. More specifically, after the package 40 is mounted on a cold plate 51 in the insulated vacuum container 50 of the cooling apparatus, and the insulated vacuum container 50 is evacuated to 10 Pa to 3 Pa, the temperature therein is cooled to a predetermined temperature (70K, for example). The cooling is performed by the combination of a freezer's expander 55 and a freezer's compressor 56.

The coaxial connectors 41 of the package 40 are coupled to hermetic coaxial connectors 58 of the insulated vacuum container 50 using coaxial cables 54 for signal input/output from and to the outside of the insulated vacuum container 50. The DC power supply coupled to the variable capacitive coupler A in the tunable filter 10 may be disposed outside the insulated vacuum container 50 along with a voltage controller (not shown).

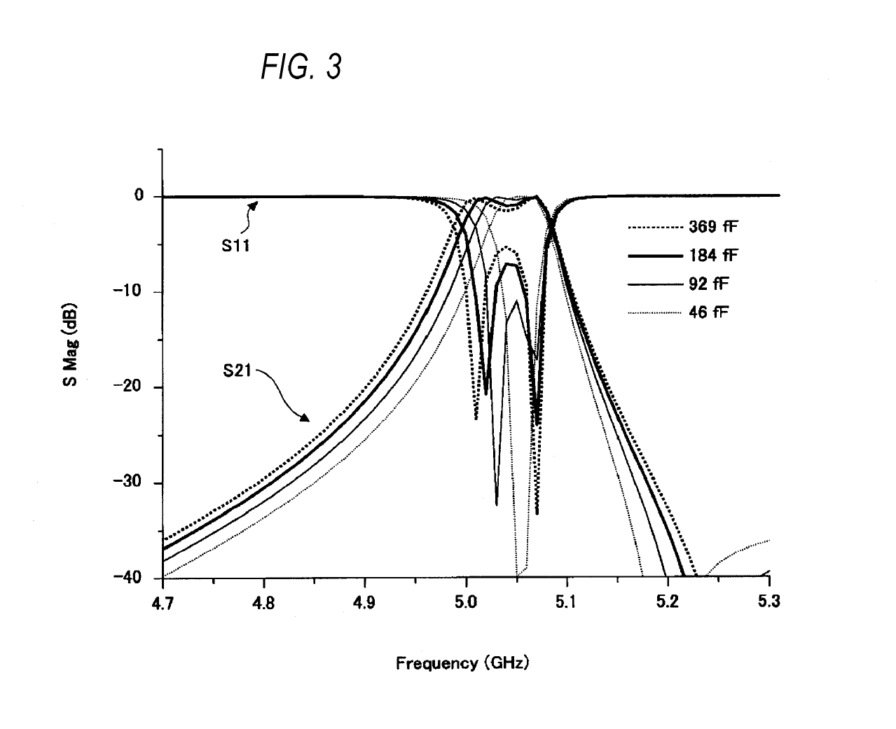

FIG. 3 shows simulation results of the filter characteristics when the capacitance is changed from the state in which no DC bias is applied (capacitance: 369 fF) to the state in which DC biases at different levels are applied. It is found that the filter characteristics are changed by applying the DC bias voltages to the thin film capacitor 21 disposed between the adjacent resonators 12a and 12b to change the coupling capacitance. Too little coupling capacitance cannot provide satisfactory filter characteristics. It is therefore necessary to set an appropriate application voltage range within which the filter characteristics are controlled according to the size of the resonator 12, the distance between the resonator 12 and the feeder 13, the size of the thin film capacitor 21, the film thickness of the dielectric 23 and the like.

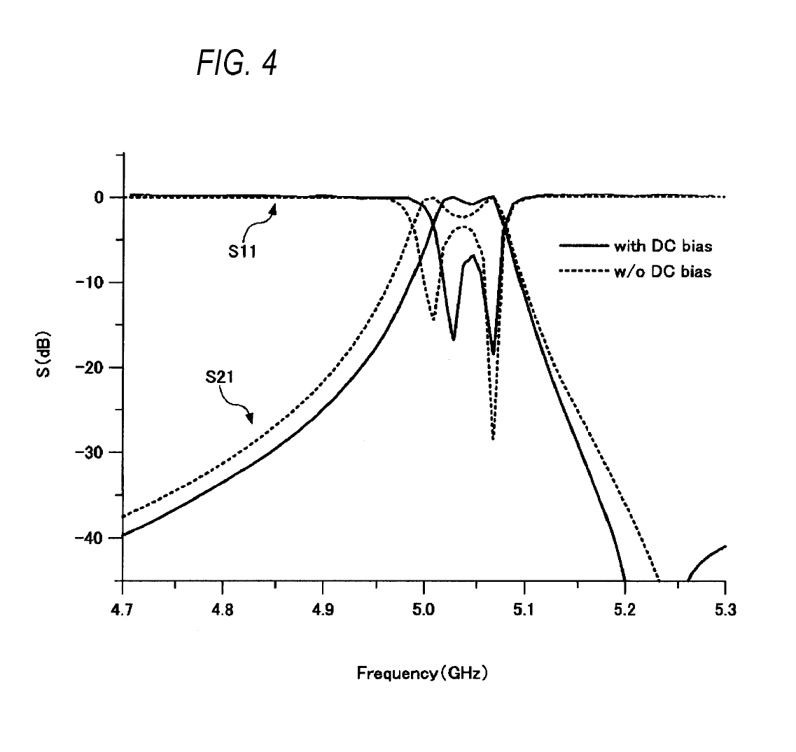

FIG. 4 shows an example of how the filter characteristics are controlled when no DC bias voltage is applied to the thin film capacitor 21 in the variable capacitive coupler A and when a fixed DC bias voltage is applied to change the coupling capacitance. By applying a DC bias at an appropriate level to the dielectric 23 in the thin film capacitor 21, it is possible to control both the bandwidth and the central frequency without increasing the absolute value of the insertion loss.

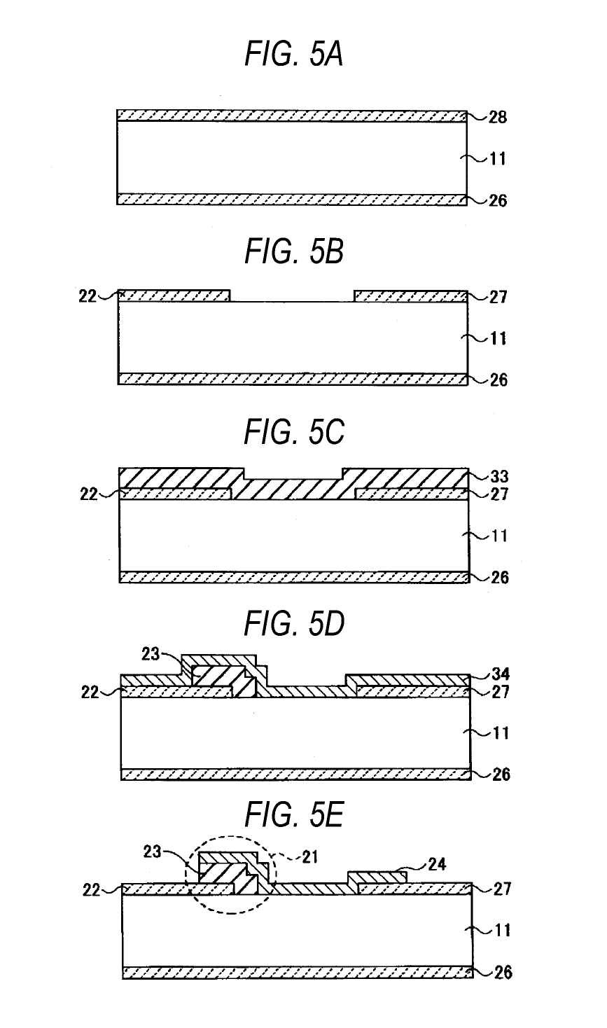

FIGS. 5A to 5E are process diagrams showing fabrication of the thin film capacitor 21 in the variable capacitive coupler A in the tunable filter shown in FIG. 1. As shown in FIG. 5A, a YBCO film is first deposited to a film thickness of 500 nm through epitaxial growth on both sides of a MgO dielectric base substrate 11 having, for example, a thickness of 0.5 mm. The YBCO film formed on the back side is a ground film 26, and the YBCO film on the front side is a superconductive material film 28 for processing the hairpin resonators 12, the signal input/output feeders 13, the bias application wiring line 14, and the electrode pattern of the variable capacitive coupler A.

As shown in FIG. 5B, a resist mask (not shown) is formed through photolithography, and the superconductive material film 28 on the front side is patterned through etching to form not only the resonators 12a and 12b, the feeders 13, and the bias application wiring line 14 but also the lower electrode 22 of the thin film capacitor at the same time. The YBCO film 27 left on the right of the lower electrode 22 is the portion coupled to the bias application wiring line 14. In this etching process, the pair of comb electrodes 15 and 16 facing each other is also simultaneously formed at the open ends of the resonators 12a and 12b and the tips of the bias application wiring line 14, respectively.

As shown in FIG. 5C, an STO thin film 33 is formed to a film thickness of 300 nm on the entire surface. Then, as shown in FIG. 5D, a resist mask (not shown) is formed through photolithography to etch the STO thin film 33 into the thin film dielectric 23 for the capacitor. Then, an electrode material film 34 is formed on the entire surface.

Finally, as shown in FIG. 5E, the electrode material film 34 is processed to form the upper electrode 24. The thin film capacitor 21 is thus completed.

In such a tunable filter, the open ends of two or more resonators are capacitance-coupled through the thin film capacitor in the same plane as that of the filter element. By externally applying a DC bias voltage to change the capacitance of the dielectric in the thin film capacitor, the coupling between the resonators can be changed. In this way, it is possible to change the bandwidth and the central frequency of the transmission band of the bandpass filter.

It is noted that the shape of the strip resonator 12 is not limited to the hairpin shape, but can be an arbitrary strip shape, such as a linear strip shape and a horseshoe shape. When three or more strip resonators are disposed, a minute thin film capacitor for capacitive coupling is similarly inserted between the resonators. In this case as well, it is desirable to form an interdigital capacitor at the open end of each of the adjacent resonators, and serially couple a thin film capacitor for capacitive coupling between the interdigital capacitors.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A tunable filter comprising:
two or more resonators adjacent to each other;
a variable capacitive coupler;
wherein that variable capacitive coupler and the two or more resonators are formed on a single substrate, and the variable capacitive coupler is provided between the two or more resonators.

2. The tunable filter according to claim 1,
wherein the variable capacitive coupler is coupled to a DC power supply.

3. The tunable filter according to claim 1,
wherein the variable capacitive coupler is formed of a capacitive coupling element provided at open ends of the two or more resonators.

4. The tunable filter according to claim 1,
wherein the variable capacitive coupler includes a capacitive coupling element having a thin film dielectric and an auxiliary capacitor capable of maintaining the capacitance of the whole tunable filter at a fixed value.

5. The tunable filter according to claim 1,
wherein the variable capacitive coupler includes interdigital capacitors provided at open ends of the two or more resonators, and a thin film capacitor coupled between the interdigital capacitors.

6. The tunable filter according to claim 2 further comprising an AC component removing filter positioned between the variable capacitive coupling element and the DC power supply.

7. The tunable filter according to claim 1,
wherein the thin film capacitor comprises a dielectric material consisting of at least one of SrTiO₃, (Ba, Sr)TiO₃, and Bi_{1.5}Zn₁Nb_{1.5}O₇.

8. The tunable filter according to claim 1,
wherein the resonators are hairpin resonators.

9. The tunable filter according to claim 1,
wherein the resonators are comprised of a superconductive material.

10. The tunable filter according to claim 6,
wherein the AC component removing filter is positioned in the same plane as the two or more resonators and the capacitive coupling element.

11. A method for fabricating a tunable filter comprising the step of:
forming two or more resonator patterns, an electrode pattern of a capacitive coupling element positioned between the two or more resonator patterns, and a wiring pattern for applying a bias voltage to the capacitive coupling element, on the same substrate during the same process step.

12. A tunable filter comprising:
two or more resonators adjacent to each other;
a variable capacitive coupler;
wherein the variable capacitive coupler and the two or more resonators are formed on a single substrate and the variable capacitive coupler is provided between the two or more resonators; and
input/output feeders,
wherein the two or more resonators, the variable capacitive coupler, and the input/output feeders are housed in a package and coupled to the outside via a coaxial connector.
